(19) United States
(12) Patent Application Publication
(10) Pub. No.: US 2009/0278361 A1
(43) Pub. Date: Nov. 12, 2009

(54) ELECTRIC POWER GENERATION DEVICE

(75) Inventors: Kazuo Okubo, Mie (JP); Sumihiro Arima, Mie (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: SHINKO ELECTRIC CO., LTD., Tokyo (JP)

(21) Appl. No.: 12/090,097

(22) PCT Filed: Oct. 11, 2006
(86) PCT No.: PCT/JP2006/320257

§ 371 Date: Jul. 14, 2009

(30) Foreign Application Priority Data
Oct. 12, 2005 (JP) 2005-297383

(51) Int. Cl. H02K 7/116; F16H 3/10; F16D 41/00; F16D 47/04

(52) U.S. Cl. 290/1 C; 74/336 R

(57) ABSTRACT

When a rotation frequency of a rotary shaft 2 is not more than a predetermined value, a clutch 7 connects the gearing systems 6 and 8 with each other. Then, the rotation from the rotary shaft 2 is accelerated through the gearing system 6, clutch 7, and gearing system 8, and is transmitted to the rotary shaft 4. At this point, a freewheel clutch 5 disconnects the rotary shafts 2 and 4 from each other. On the other hand, when the rotation frequency of the rotary shaft 2 surpasses the predetermined value, the clutch 7 disconnects the gearing systems 6 and 8 from each other. Then, the rotation frequency of the rotary shaft 4 drops. When the rotation frequency of the rotary shaft 2 equals that of the rotary shaft 4, the freewheel clutch 5 connects the rotary shafts 2 and 4 with each other, thereby transmitting the rotation from the rotary shaft 2 as it is to the rotary shaft 4 via the freewheel clutch 5.

### TECHNICAL FIELD

The present invention relates to a power generating device for generating power by using an externally applied rotational force.

### BACKGROUND ART

There has been a power generating device which generates power by transmitting rotation from an engine or the like to a power generator, while increasing the rotational frequency of the rotation through the process of transmitting the rotation. In such a power generating device however, the rotation frequency of the power generator increases with an increase in the rotation frequency of the engine, thus imposing a large centrifugal force to the power generator. This may consequently damage the power generator. To avoid this, the power generator needs to be upsized to be resistant against such a centrifugal force. In order to achieve such a problem, Patent Document 1 discloses a power generating device including: a first rotary shaft rotated by a rotation of an engine; a second rotary shaft rotated by the rotation of the first rotary shaft; and a power generator rotated by the rotation of the second rotary shaft, wherein: the first rotary shaft includes two pulleys each of which is selectively switched by means of an electromagnetic clutch, between modes of rotating and not rotating along with the rotation of the first rotary shaft; and the second rotary shaft includes two pulleys which respectively have different diameters, and which are connected the two pulleys of the first rotary shaft. When the rotation frequency of the engine is low, one of the pulleys of the first rotary shaft connected to one of the pulleys of the second rotary shaft having a smaller diameter is rotated along with the rotation of the first rotary shaft. On the other hand, when the rotation frequency of the engine is high, one of the pulleys of the first rotary shaft connected to one of the pulleys of the second rotary shaft having a larger diameter is rotated along with the rotation of the first rotary shaft. Thus, it is possible to efficiently generate a power when the rotation frequency of the engine is low, while preventing a damage to the power generator when the rotation frequency of the engine is high.

[Patent Document 1] Japanese Registered Utility Model 3097549 (FIG. 2)

### DISCLOSURE OF THE INVENTION

### Technical Problem

However, the power generating device of Patent Document 1 requires a complex structure having the first and second rotary shafts between an engine and the power generator, wherein the first rotary shaft includes a plurality of pulleys each of which is selectively switched by means of an electromagnetic clutch, between modes of rotating and not rotating along with the rotation of the first rotary shaft; and the second rotary shaft includes a plurality of pulleys respectively having different diameters, which rotate with the second rotary shaft and are connected to the plurality of pulleys of the first rotary shaft.

An object of the present invention is to provide a simply structured power generating device capable of efficiently generating power when the rotation frequency of an engine is low, and preventing a damage to the power generator even when the rotation frequency of the engine is high.

### Technical Solution and Advantageous Effects

A power generating device of the present invention includes: a first rotary shaft rotated by an external rotational force; a second rotary shaft rotated by the rotation from the first rotary shaft; a power generator rotated by the rotation from the second rotary shaft, which generates a power; first transmitting means for transmitting the rotation of the first rotary shaft as it is to the second rotary shaft; second transmitting means for increasing the rotation frequency of the rotation received from the first rotary shaft, and transmitting the rotation with the increased rotation frequency to the second rotary shaft. The first transmitting means includes first connecting means for (i) disconnecting the first and second rotary shafts from each other when a rotation frequency of the first rotary shaft is not more than a predetermined value, and (ii) connecting the first and second rotary shafts with each other when the rotation frequency of the first rotary shaft surpasses the predetermined value. The second transmitting means includes: (A) an acceleration gearing system having a plurality of gears, which increases the rotation frequency of the rotation received from the first rotary shaft, and transmits the rotation with the increased rotation frequency to the second rotary shaft, and (B) second connecting means for (i) connecting the first and second rotary shafts with each other via the acceleration gearing system when the rotation frequency of the first rotary shaft is not more than the predetermined value, and (ii) disconnecting the first and second rotary shafts connected via the gearing system from each other when the rotation frequency of the rotary shaft surpasses the predetermined value.

With this, the first connecting means disconnects the first and second rotary shafts from each other when a rotation frequency of the first rotary shaft is not more than a predetermined value, and connects the first and second rotary shafts with each other when the rotation frequency of the first rotary shaft surpasses the predetermined value. Accordingly, even when the rotation frequency of the first rotary shaft is low, the rotation frequency of the power generator rotating with the second rotary shaft is kept from dropping too low a frequency, and power generation is surely performed. On the other hand, when the rotation frequency of the first rotary shaft surpasses the predetermined value, the first connecting means connects the first and second rotary shafts with each other, and the second connecting means disconnects the first and second rotary shafts which are connected with each other via the acceleration gearing system. Thus, the rotation of the first rotary shaft is transmitted as it is to the second rotary shaft. Accordingly, even when the rotation frequency of the first rotary shaft is high, it is possible to avoid occurrence of a large centrifugal force, and damaging the power generator rotating with the second rotary shaft by the centrifugal force. Further, it is not necessary to upsize the power generator so as to make it resistant against a large centrifugal force. Therefore, the downsizing of the entire device is possible. Further, since the acceleration gearing system of the second transmitting means includes a plurality of gears, the structure of the device is simplified, and the maintenance of the device will be easy.

Further, the power generating device of the present invention may be adapted so that the first connecting means is a freewheel clutch including: a first rotating member which rotates with the first rotary shaft; a second rotating member which rotates with the second rotary shaft; and a connecting member which (i) connects the first and second rotating members with each other when the rotation frequency of the first rotating member is not lower than the rotation frequency of the second rotating member, and (ii) disconnects the first and second rotating members from each other when the rotation frequency of the first rotating member is lower than the rotation frequency of the second rotating member. In this structure, the first connecting means is a freewheel clutch. Therefore, when the rotation frequency of the first rotary shaft is not more than a predetermined value, the second connecting means connects the first and the second rotary shafts via the acceleration gearing system, and the rotation frequency of the rotation from the first rotary shaft is increased and is transmitted to the second rotary shaft. Therefore, the rotation frequency of the first rotary shaft is lower than that of the second rotary shaft, and the first and the second rotating members connected via connecting members are disconnected from each other. On the other hand, when the rotation frequency of the first rotary shaft surpasses the predetermined value, the second connecting means disconnects the first and second rotary shafts which are connected to each other via the acceleration gearing system. Therefore the rotation frequency of the second rotary shaft drops, and when the rotation frequency reaches the rotation frequency of the first rotary shaft, the first and the second rotating members are connected via the connecting members. Accordingly, it is possible to realize the entire device with a simple structure in which the first and the second rotary shafts are connected/disconnected to/from each other by means of the freewheel clutch.

Further, the power generating device of the present invention may be adapted so that the first and second rotary shafts are disposed along a single straight line; and the acceleration gearing system of the second transmitting means and the second connecting means are disposed so that their respective barycenters are positioned along the straight line. This structure restrains vibration occurring while the rotation of the first rotary shaft is transmitted to the second rotary shaft.

Further, a power generating device of the present invention includes: a first rotating member which rotates with an external rotational force; a second rotating member rotated, in a direction opposite to the first rotating member, by the external rotational force; a power generator including (i) a rotor which rotates with the first rotating member, and (ii) a stator disposed so as to surround the rotor, which rotates with the second rotating member, in a direction opposite to the rotor; and a stopping member which stops the rotation of the second rotating member, wherein the stopping member stops the rotation of the second rotating member when the rotation frequency of the first rotating member surpasses a predetermined value.

With this, when the rotation frequency of the first rotating member is not more than a predetermined value, the first rotating member rotates and the second rotating member rotates in a direction opposite to the first rotating member. Therefore, the rotor rotates relative to the stator, at a rotation frequency which is the sum of the rotation frequencies of the rotor and the stator, and therefore enables power generation even when the rotation frequency of the first rotating member is low. On the other hand, when the rotation frequency of the first rotating member surpasses a predetermined value, the first rotating member rotates and thereby rotates the rotor, while the stopping mechanism stops the rotation of the second rotating member. The rotor therefore rotates relative to the stator at the rotation frequency of its own, thereby generating power. As described, the rotation frequency of the rotor relative to the stator is increased by rotating the stator and the rotor in the opposite directions to each other, instead of, for example, transmitting the rotation from the first rotating member to the rotor, while increasing the rotation frequency of the rotation through the process of transmitting the rotation. Thus, when the rotation frequency of the first rotating member is increased, the rotation frequency of the rotor on the other hand is not increased by much. Therefore, a large centrifugal force does not occur in the power generator. Thus, it is not necessary to upsize the power generator to make it resistant against a large centrifugal force. Further, it is possible to realize the device with a simple structure.

### BEST MODE FOR CARRYING OUT THE INVENTION

The following describes a suitable embodiment of the present invention, with reference to the attached drawings.

FIG. 1 is a diagram schematically showing a structure of a power generating device of the embodiment, according to the present invention. As shown in FIG. 1, a power generating device 100 includes: a rotating plate 1; a rotary shaft (first rotary shaft) 2; a power generator 3; a rotary shaft (second rotary shaft) 4; a freewheel clutch (first connecting means) 5; gearing systems (acceleration gearing systems) 6 and 8; and a clutch (second connecting means) 7. The rotating plate 1 is rotated by a rotational force externally applied thereto. For example, the power generating device 100 is connected to a not-shown engine, and rotates at a rotation frequency increased at a predetermined rate from the rotation frequency of the engine. The rotary shaft 2 rotates with the rotating plate 1.

The power generator 3 includes: a rotor 3a, and two permanent magnet 3b disposed so as to interpose therebetween the rotor 3a. In this power generator 3, DC power is generated through rotation of the rotor 3a between the two permanent magnet 3b. The rotary shaft 4 is connected to the rotor 3a of the power generator 3. The rotation of this rotary shaft 4 rotates the rotor 3a.

As shown in FIGS. 2 and 3, the freewheel clutch 5 includes: an inner ring (first rotating member ) 11 which rotates with the rotary shaft 2; an outer ring (second rotating member ) 12 which rotates with the rotary shaft 4; and a plurality of connecting members 13 disposed between the inner ring 11 and the outer ring 12. In the freewheel clutch 5, when the rotation frequency of the inner ring 11 (the rotation frequency of the rotary shaft 2) is not lower than the rotation frequency of the outer ring 12 (the rotation frequency of the rotary shaft 4), the inner ring 11 and the outer ring 12 are connected to each other via the connecting members 13, and thus the inner ring 11 and the outer ring 12 rotate together. On the other hand, when the rotation frequency of the inner ring 11 is lower than the rotation frequency of the outer ring 12, the connecting members 13 is slanted towards the rotation direction of the outer ring 12. Therefore, the inner ring 11 and the outer ring 12 are disconnected from each other, and rotate independently from each other. The rotation frequency of the inner ring 11 equals or surpasses that of the outer ring 12 when the rotation frequency of the rotary shaft 2 is not more than a predetermined value, as hereinafter detailed. Further, the rotation frequency of the inner ring 11 is lower than the rotation frequency of the outer ring 12 when the rotation frequency of the rotary shaft 2 surpasses the predetermined value, as hereinafter detailed. Thus, the freewheel clutch 5 disconnects the rotary shafts 2 and 4 from each other when the rotation frequency of the rotary shaft 2 is not more than the predetermined value, and connects the rotary shafts 2 and 4 with each other when the rotation frequency of the rotary shaft 2 surpasses the predetermined value.

The gearing system 6 includes a plurality of gears which rotate with the rotary shaft 2. The gearing systems 8 includes a plurality of gears which rotate with the rotary shaft 4. The clutch 7 is an electromagnetic clutch for example, and connects/disconnects the gearing systems 6 and 8 with/from each other. Specifically, for example, when the rotation frequency of the rotary shaft 2, detected by a not-shown rotation frequency meter or the like, is not more than the predetermined value, the clutch 7 connects the rotary shaft 2 with the gearing system 6. On the contrary, when the detected rotation frequency of the rotary shaft 2 surpasses the predetermined value, the clutch 7 disconnects the gearing systems 6 and 8 from each other. When the gearing systems 6 and 8 are connected with each other by the clutch 7, the rotation from the rotary shaft 2 is accelerated through the gearing system 6, clutch 7, and gearing system 8, and is transmitted to the rotary shaft 4. At this point, in the freewheel clutch 5, the rotation frequency of the inner ring 11 is lower than that of the outer ring 12. Therefore, the inner ring 11 and the outer ring 12 connected via the connecting members 13 are disconnected. Note that the predetermined value of the rotation frequency can be any given value. However, in the present embodiment, the predetermined value of the rotation frequency is the rotation frequency of the rotary shaft 2 where the rotation frequency of the engine is 1100 rpm.

Next, the following describes an operation of the power generating device 100, with reference to FIGS. 1 and 4. FIG. 4 is a diagram showing a relation between the rotation frequency of the not shown engine and that of the power generator 3, where: the straight line L1 shows a relation between the rotation frequency of the engine and that of the power generator 3 when transmitting the rotation from the rotary shaft 2 to the rotary shaft 4, while increasing the rotational frequency through the gearing system 6, clutch 7 and gearing system 8; and the straight line L2 shows a relation between the rotation frequency of the engine and that of the power generator when the rotation from the rotary shaft 2 is transmitted to the rotary shaft 4 via the freewheel clutch 5.

When the rotation frequency of the engine is not more than 1100 rpm; i.e., the rotation frequency of the rotary shaft 2 is not more than a value resulted by increasing the rotation frequency of 1100 rpm at a predetermined rate, the gearing systems 6 and 8 are connected to each other by the clutch 7, and the rotation from the rotary shaft 2 is accelerated through the gearing system 6, clutch 7, and gearing system 8, and is transmitted to the rotary shaft 4. At this point, the rotation frequency of the rotary shaft 2 is lower than that of the rotary shaft 4. Therefore, in the freewheel clutch 5, the inner ring 11 and the outer ring 12 connected via the connecting members are disconnected from each other and rotate independently from each other. In this case, the rotation of the rotary shaft 2 is transmitted to the rotary shaft 4, while being accelerated to meet the relation of the straight line L1 of FIG. 4.

When the rotation frequency of the engine increases from the above state and surpasses 1100 rpm; i.e., when the rotation frequency of the rotary shaft 2 surpasses a value resulted by increasing the rotation frequency of 1100 rpm at a predetermined rate, the connection of the gearing systems 6 and 8 are disconnected from each other by the clutch 7. Then, the rotation of the rotary shaft 2 is no longer transmitted to the rotary shaft 4 via the gearing system 6, clutch 7, and gearing system 8. Therefore, the rotation frequency of the rotary shaft 4 is gradually decreased. Then, when the rotation frequency of the rotary shaft 4 drops and reaches the rotation frequency of the rotary shaft 2, the inner ring 11 and the outer ring 12 are connected via the connecting members 13 in the freewheel clutch 5, and the rotary shafts 2 and 4 rotate together. That is, the rotation of the rotary shaft 2 is transmitted to the rotary shaft 4 via the freewheel clutch 5, and the rotation frequency is kept unchanged so as to meet the relation shown by the line L2 of FIG. 4.

When the rotation frequency of the engine drops from the above state to 1100 rpm or lower, the gearing systems 6 and 8 are connected again by the clutch 7. Then, the rotation from the rotary shaft 2 is accelerated through the gearing system 6, clutch 7, and gearing system 8, and is transmitted to the rotary shaft 4. At this point, the rotation frequency of the rotary shaft 4 surpasses that of the rotary shaft 2, and therefore the inner ring 11 and the outer ring 12 connected via the connecting members 13 are disconnected in the freewheel clutch 5, and the rotary shafts 2 and 4 rotate independently from each other.

For example, as shown in FIG. 4, when a rotation frequency of an engine which can normally operate the power generating device 100 ranges 550 rpm to 2300 rpm, power is efficiently generated through the above described operation, even if the rotation frequency is the minimum value of 550 rpm, because the power generator 3 rotates at 4000 rpm. Further, even when the rotation frequency of the engine is the maximum frequency of 2300 rpm, the rotation frequency of the power generator 3 is restrained to approximately 8727 rpm, and it is therefore possible to prevent an occurrence of a large centrifugal force that damages the power generator 3. Further, it is not necessary to upsize the power generator 3 to make it resistant against a large centrifugal force.

In the embodiment, the gearing systems 6 and 8 are connected by the clutch 7, when the rotation frequency of the rotary shaft 2 is not more than a predetermined value (a value resulted by increasing 1100 rpm at a predetermined rate), so that the rotation from the rotary shaft 2 is accelerated and transmitted to the rotary shaft 4. This ensures power generation even when the rotation frequency of the rotary shaft 2 is low.

On the other hand, when the rotation frequency of the rotary shaft 2 surpasses the predetermined value, the clutch 7 disconnects the gearing systems 6 and 8 from each other, and the rotation from the rotary shaft 2 is not transmitted to the rotary shaft 4 through the gearing system 6, clutch 7 and gearing system 8. Therefore, the rotation frequency of the rotary shaft 4 drops. When the rotation frequency of the rotary shaft 4 reaches that of the rotary shaft 2, the inner ring 11 and the outer ring 12 are connected to each other via the connecting members 13 and rotate together in the freewheel clutch 5. In short, the rotation of the rotary shaft 2 is transmitted as it is to the rotary shaft 4, through the freewheel clutch 5. Accordingly, even when the rotation frequency of the rotary shaft 2 is high, it is possible to avoid occurrence of a large centrifugal force in the power generator 3 and damaging the power generator 3 by the large centrifugal force. Further, it is not necessary to upsize the power generator 3 to make it resistant against a centrifugal force. It is thus possible to downsize the entire device.

Further, the connection and disconnection of the rotary shafts 2 and 4 are performed by the freewheel clutch 5, and those of the gearing systems 6 and 8 are performed by the clutch 7. Therefore, the overall structure of the entire device is simplified.

Further, with the use of the gearing systems 6 and 8 for transmitting the rotation from the rotary shaft 2 to the rotary shaft 4, while increasing the rotation frequency through the process of transmitting the rotation, the structure is simplified and the maintenance of the device becomes easier.

Next, the following describes various alternative forms of the above embodiment of the present invention.

A structure as shown in FIG. 5 is also possible. Namely, a rotary shaft 22 (first rotary shaft) and a rotary shaft 4 are disposed along the straight line C. This rotary shaft 22 is connected to a rotating plate 21, and the rotary shaft 4 rotates a power generator 3. Between the rotary shafts 22 and 4, a freewheel clutch 5 is provided. Further, gears 23 and 24 and a clutch 25 are arranged so that their barycenters are positioned along the straight line C. Through the gears 23 and 24 and the clutch 25, the rotation from the rotary shaft 22 is accelerated and is transmitted to the rotary shaft 4. In the case of FIG. 5, the gear 23 which rotates with the rotary shaft 22 is disposed so as to rotate about the rotary shaft 22. The gears 24 which rotate with the gear 23 is disposed around the periphery of the gear 23 so that the barycenter of a group of gears 24 is positioned along the straight line C. Further, the clutch 25 which connects/disconnects the group of gears 24 with/from the rotary shaft 4 is disposed so that the barycenter thereof is positioned along the straight line C, and that the freewheel clutch 5 is surrounded by the clutch 25. In this case, when the rotation frequency of the rotary shaft 22 is not more than a predetermined value, the clutch 25 connects the gears 24 with the rotary shaft 4. On the other hand, when the rotation frequency surpasses the predetermined value, the clutch 25 disconnects the gears 24 and the rotary shaft 4 from each other.

When the gears 24 and the rotary shaft 4 are connected to each other by the clutch 25, the rotation from the rotary shaft 22 is accelerated through the gears 23 and 24 and clutch 25, and is transmitted to the rotary shaft 4. At this point, the rotation frequency of the rotary shaft 22 is lower than that of the rotary shaft 4. Therefore, the inner ring 11 and the outer ring 12 of the freewheel clutch 5 connected via the connecting members 13 are disconnected (See FIGS. 2 and 3), and the rotary shafts 22 and 4 rotate independently from each other. On the other hand, when the gears 24 and the rotary shaft 4 are disconnected from each other by the clutch 25, the inner ring 11 and the outer ring 12 are connected via the connecting members 13 (see FIGS. 2 and 3) in the freewheel clutch 5, as is the case of the above embodiment. In short, the rotation of the rotary shaft 22 is transmitted as it is to the rotary shaft 4.

As in the embodiment, the power generator 3 of this alternative form is able to efficiently generate power, even when the rotation frequency of the engine; i.e., the rotation frequency of the rotary shaft 22, is low. Further, even when the rotation frequency of the rotary shaft 22 is high, it is possible to prevent the power generator 3 from being damaged by a large centrifugal force occurring in the power generator 3. Thus, there is no need to upsize the power generator 3 to make it resistant against a large centrifugal force.

Further, since the barycenters of the gear 23, the group of gears 24, and the clutch 25 are all positioned along the straight line C, vibration which occurs at the time of transmitting rotation is restrained.

In the embodiment, the freewheel clutch 5 is used to connect the rotary shafts 2 and 4. However, it is possible to adopt a clutch in place of the freewheel clutch 5, as long as the clutch disconnects the rotary shafts 2 and 4 from each other when the rotation frequency of the rotary shaft 2 is not more than a predetermined value, and connects the rotary shafts 2 and 4 with each other when the rotation frequency of the rotary shaft 2 surpasses the predetermined value.

In another alternative form as shown in FIG. 6, a power generating device 200 includes: a pulley (first rotating member) 31; a pulley (second rotating member) 32; a power generator 33; rotary shafts 34 and 35; a clutch mechanism (stopping mechanism) 36; a cover 37; and a plurality of bearings 38a to 38e.

The pulley 31 rotates with the rotation of a not shown engine; i.e., by the rotational force externally applied. The pulley 32 is arranged rightward of the pulley 31 in FIG. 6, and rotates with the rotation of the engine in a direction opposite to the rotation of the pulley 31. Further, the pulley 32 has a through hole through which the rotary shafts 34 and 35 penetrate. This through hole is provided substantially at the center of the pulley 32. The power generator 33 includes: a rotor 33a, a permanent magnet (stator) 33b, and a rotary frame 33c. The rotor 31 is arranged substantially at the center of the power generator 33, and rotates with the rotation of the rotary shaft 34 transmitted thereto via the pulley 31. The permanent magnet 33b is arranged so as to surround the rotor 33a and is fixed to the rotary frame 33c. The rotary frame 33c is rotated by the rotation from the pulley 32 transmitted through the rotary shaft 35, along with the permanent magnet 33b, in the opposite direction to the rotation of the rotor 31a.

The rotary shaft has an end connected substantially in the center of the pulley 31, and is extended, in a left/right direction of the figure, to the opposite side of the power generator 33 penetrating the pulley 32, clutch mechanism 36, casing 37, and the rotor 33a. Further, the rotary shaft 35 has a hollow center through which the rotary shaft 34 is penetrated.

The clutch mechanism 36 is arranged rightward of the pulley 32 in the figure, and includes: a base material 36a, a tooth 36b, and a pressing mechanism 36c. The base material 36 possesses elasticity, and is provided substantially at its center with a through hole through which the rotary shafts 34 and 35 are penetrated. The tooth 36b is made of a rubber material or the like, and is fixed at a periphery portion on the surface of the base material 36a facing the pulley 32. The pressing mechanism 36c is structured so as to press a portion on the surface of the base material 36a facing the power generator, which portion is opposite to the tooth 36b, towards the pulley 32 (to the left of the figure). When the rotation frequency of the pulley 31 (i.e., the rotation frequency of the engine) surpasses a predetermined value, the portion opposite to the tooth 36b of the base material 36a is pressed by the pressing mechanism 36c towards the pulley 32. By having the pressing mechanism 36c pressing the portion towards the pulley 32 in the clutch mechanism 36, the tooth 36b contacts the surface of the pulley 32, thereby stopping the rotation of the pulley 32 with the friction between the pulley 32 and the tooth 36b.

The cover 37 covers the power generator 33, and the bearings 38a to 38e are respectively arranged: between the through hole of the base material 36a and the rotary shaft 35; between the rotary shaft 35 and the cover 37; between the rotary shaft 34 and the rotary shaft 35; between the rotary frame 33c and the rotary shaft 34; and between the cover 37 and the rotary frame 33c. The bearings 38a to 38e allow smooth rotation of the pulleys 31 and 32, the rotary shafts 34 and 35, the rotor 33a, and the rotary frame 33c.

In the power generating device 200, the pressing mechanism 36 does not press the material 36a when the rotation frequency of the not-shown engine (the rotation frequency of pulley 31) is not more than a predetermined value, and therefore the both pulleys 31 and 32 rotate with the rotation of the engine. This rotates the rotor 33a and the rotary frame 33c (permanent magnet 33b) in the opposite directions. Thus rotor 33a rotates relative to the permanent magnet 33b at a rotation frequency which is the sum of the rotation frequencies of the rotor 33a and the rotary frame 33c, and the power generator 33 generates a power. As described, even when the rotation frequency of the engine is low, it is possible to ensure that the power generator 33 generates power.

On the other hand, when the rotation frequency of the not-shown engine surpasses the predetermined value, the portion of the base material 36a opposite to the tooth 36b is pressed against the pulley 32 by the pressing mechanism 36c, thereby causing the tooth 36b to contact the surface of the pulley 32. The friction generated between the tooth 36b and the pulley 32 stops the rotation of the pulley 32, and thereby stops the rotation of the rotary frame 33c (permanent magnet 33b). At this point, the pulley 31 rotates with the rotation of the engine, and the rotor 33a rotates with the rotation of the pulley 31. Thus, the rotor 33a rotates relative to the permanent magnet 33b at its own rotation frequency, and the power generator 33 generates power with the rotation.

As described, the rotation frequency of the rotor 33a relative to the permanent magnet 33b is increased by rotating the rotary frame 33c and the rotor 33a in the opposite directions to each other, instead of increasing the rotation frequency of the rotor 33a itself by, for example, accelerating the rotation from the pulley 31 and transmitting the rotation to the rotor 33a. Thus, when the rotation frequencies of the engine and the pulley 31 are increased, the rotation frequency of the rotor 33a on the other hand is not increased by much. Therefore, it is not necessary to upsize the power generator 33 to make it resistant against a large centrifugal force. Further, it is possible to realize a power generating device 200 with a simple structure as shown in FIG. 6.

### BRIEF DESCRIPTION OF THE DRAWINGS

FIG. 1 is a diagram schematically showing a structure of a power generating device of an embodiment, according to the present invention.

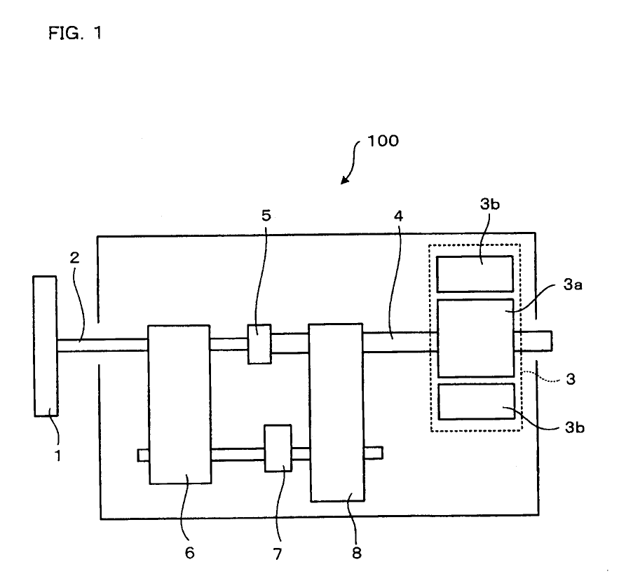

FIG. 2 is a cross sectional view of a freewheel clutch shown in FIG. 1.

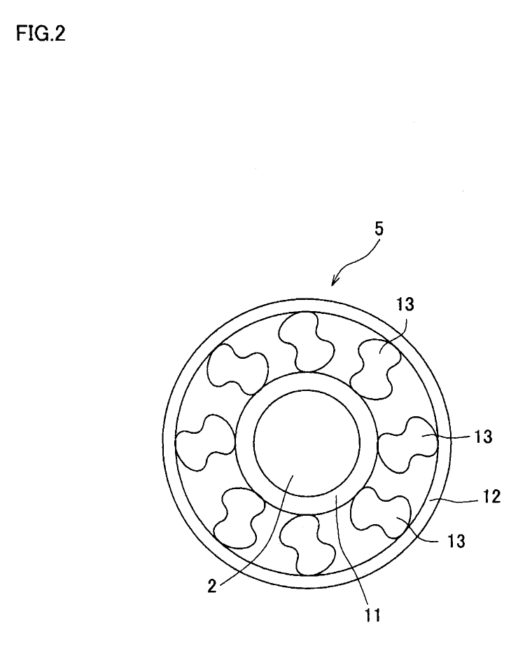

FIG. 3 is a diagram showing a side view of FIG. 2.

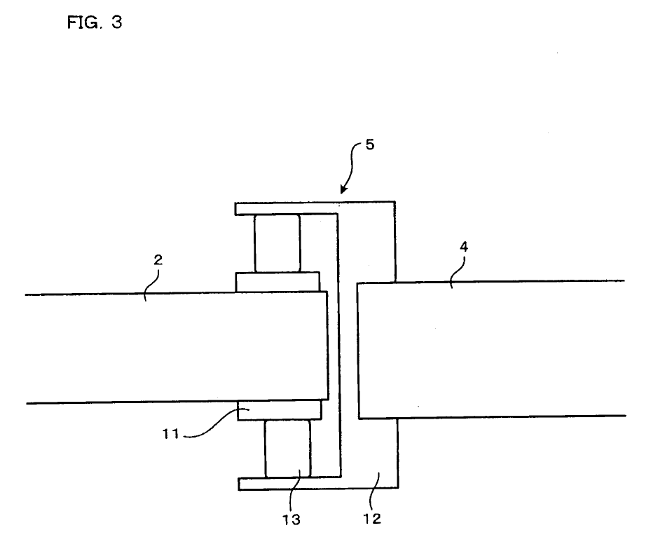

FIG. 4 is a diagram showing a relation between the rotation frequency of an engine and that of the power generator shown in FIG. 1.

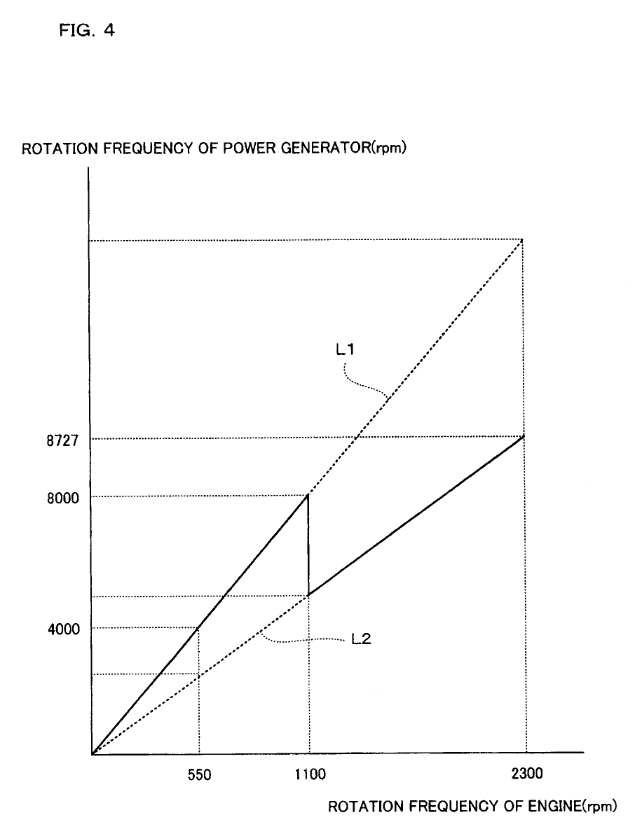

FIG. 5 is a diagram schematically showing a structure where the barycenters of gears are on a straight line along the rotary shaft.

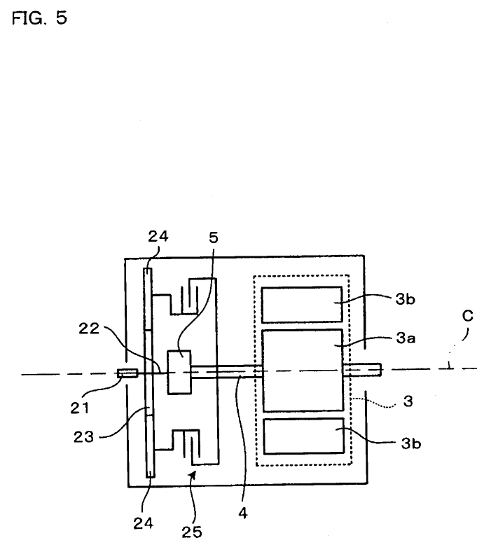

FIG. 6 is a diagram schematically showing a structure of an alternative form of the power generating device in the power generator, in which device a rotor and a permanent magnet are both rotatable.

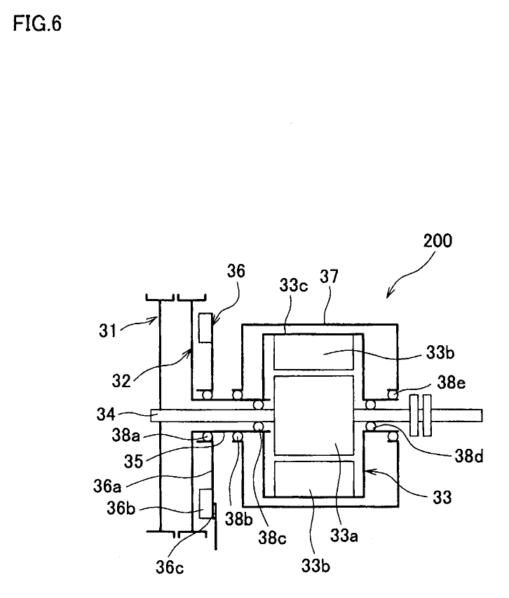

### REFERENCE NUMERALS

2 Rotary Shaft

3 Power Generator

4 Rotary Shaft

5 Freewheel Clutch

6 Gearing Systems

7 Clutch

8 Gearing Systems

22 Rotary Shaft

23 Gear

24 Gear

25 Clutch

31 Pulley

32 Pulley

33 Power Generator

33a Rotor

33b Permanent Magnet

33c Rotary Frame

36 Clutch Mechanism

100 Power Generating Device

200 Power Generating Device

1. A power generating device, comprising:
a first rotary shaft rotated by an external rotational force;
a second rotary shaft rotated by the rotation from the first rotary shaft;
a power generator rotated by the rotation from the second rotary shaft, which generates a power;
first transmitting means for transmitting the rotation from the first rotary shaft as it is to the second rotary shaft;
second transmitting means for increasing the rotation frequency of the rotation received from the first rotary shaft, and transmitting the rotation with the increased rotation frequency to the second rotary shaft, wherein
the first transmitting means includes first connecting means for (i) disconnecting the first and second rotary shafts from each other when a rotation frequency of the first rotary shaft is not more than a predetermined value, and (ii) connecting the first and second rotary shafts with each other when the rotation frequency of the first rotary shaft surpasses the predetermined value, and
the second transmitting means includes: (A) an acceleration gearing system having a plurality of gears, which increases the rotation frequency of the rotation received from the first rotary shaft, and transmits the rotation with the increased rotation frequency to the second rotary shaft, and (B) second connecting means for (i) connecting the first and second rotary shafts with each other via the acceleration gearing system when the rotation frequency of the first rotary shaft is not more than the predetermined value, and (ii) disconnecting the first and second rotary shafts connected via the gearing system from each other when the rotation frequency of the rotary shaft surpasses the predetermined value.

2. The device according to claim 1, wherein:
the first connecting means is a freewheel clutch including:
a first rotating member which rotates with the first rotary shaft;
a second rotating member which rotates with the second rotary shaft; and
a connecting member which (i) connects the first and second rotating members with each other when the rotation frequency of the first rotating member is not lower than the rotation frequency of the second rotating member, and (ii) disconnects the first and second rotating members from each other when the rotation frequency of the first rotating member is lower than the rotation frequency of the second rotating member.

3. The device according to claim 1, wherein
the first and second rotary shafts are disposed along a single straight line; and
the acceleration gearing system of the second transmitting means and the second connecting means are disposed so that their respective barycenters are positioned along the straight line.

4. A power generating device, comprising:
a first rotating member which rotates with an external rotational force;
a second rotating member rotated, in a direction opposite to the first rotating member, by the external rotational force;
a power generator including (i) a rotor which rotates with the first rotating member, and (ii) a stator disposed so as to surround the rotor, which rotates with the second rotating member, in a direction opposite to the rotor; and
a stopping member which stops the rotation of the second rotating member, wherein
the stopping member stops the rotation of the second rotating member when a rotation frequency of the first rotating member surpasses a predetermined value.
